(19) United States
(12) Patent Application Publication
(10) Pub. No.: US 2008/0170611 A1
(43) Pub. Date: Jul. 17, 2008

(54) Configurable functional multi-processing architecture for video processing

(76) Inventor: Srikrishna Ramaswamy, Austin, TX (US)

Correspondence Address: ANDREWS KURTH LLP;Intellectual Property Department, Suite 1100, 13501 I Street, N.W., Washington, DC, 20005, US

(21) Appl. No.: 11/878,212

(22) Filed: Jul. 23, 2007

Related U.S. Application Data
(60) Provisional application No. 60/880,727, filed on Jan. 17, 2007.

(51) Int. Cl. H04B 1/66

(52) U.S. Cl. 375/240.01; 375/E07.026

(57) ABSTRACT

A configurable functional multi-processing architecture for video processing. The architecture may be utilized as integrated circuit devices for video compression based on multi-processing at a functional level. The architecture may also provide a function based multi-processing system for video compression and decompression and systems and methods for development of integrated circuit devices for video compression based on multi-processing at a functional level. A function based multi-processing system for video compression and decompression includes one or more functional elements, a high performance video pipeline, a video memory management unit, one or more busses for communication, and a system bus for communication between higher level system resources, functional elements, video pipeline, and video memory management unit. Each functional element selectively includes one or more customized processor elements, one or more hardwired accelerator elements or one or more customized processor elements and hardwired accelerator elements.

### CROSS-REFERENCE TO RELATED APPLICATION(S)

This application claims priority from U.S. Provisional Application 60/880,727 filed Jan. 17, 2007 entitled “CONFIGURABLE FUNCTIONAL MULTI-PROCESSING ARCHITECTURE FOR VIDEO PROCESSING” the content of which is incorporated herein in its entirety to the extent that it is consistent with this invention and application.

### BACKGROUND

Video compression is the most critical component of many multimedia applications available today. For applications such as DVD, digital television broadcast, satellite TV, video streaming and conferencing, video recorders, limited transmission bandwidth or storage capacity stresses the demand for higher video compression. To address these different scenarios, many video compression standards have been ratified over the past decade.

The original impetus for digital video compression occurred with the early implementation of video conferencing and video telephony where it was essential to compress an analog video signal into a format that could be transmitted over phone lines at low bit rates. Standardization in this sector by the International Telecommunications Union (ITU) resulted in the development of standards with the ITU-T H.26x designation, H.261, H.262 (MPEG2), H.263, and now H.264.

The International Standards Organization (ISO) also established a series of standards for video coding denoted with the MPEG-x designation, in particular MPEG-1, MPEG-2, and more recently MPEG-4. The MPEG-2 standard, developed a decade ago as an extension to MPEG-1 with support for interlaced video was an enabling technology for digital television systems worldwide. It is currently widely used for transmission of standard definition (SD), and High Definition (HD) TV signals over satellite, cable and terrestrial emission and the storage of high-quality SD video signals onto DVDs.

However, an increasing number of services and growing popularity of HDTV is creating greater needs for higher coding efficiency. Applications like streaming video, DVD players, DVD recorders with the ability to simultaneously record to and playback from hard disk drives are driving the need to digitally compress broadcast video over cable, DSL, and over satellite.

All of these applications need the ability to support broadcast quality, and now they must provide a migration path to higher resolution HDTV.

To address the above needs, the ITU and ISO committees combined their efforts to draft a new standard that would double the coding efficiency in comparison to the most widely used video coding standard for a wide range of applications. This standard, designated as H.264, or MPEG-4, part 10, provides advances not only in coding efficiency, but also in transmission resiliency and video quality. H.264 shares a number of common features with past standards, including H.263 and MPEG-4. H.264 extends the state of the art by adopting more efficient coding techniques and new, more sophisticated implementation options to deliver enhanced video capability.

The dramatic improvement in coding efficiency, resiliency and video quality provided by advanced standards like H.264 come at a price: a steep increase in compute complexity. New architectural approaches in silicon are desired in order to achieve and maintain desired frame rates at High Definition resolutions, while keeping costs at levels reasonable enough to bolster consumer acceptance.

Well entrenched existing standards like MPEG-1, MPEG-2, and MPEG-4 necessitate that next-generation video processors provide support for these legacy standards during the transitional phase, while two other upcoming standards similar to H.264, VC-1 (proposed by Microsoft) and AVS (Chinese next generation video standard. Critical, is the support for H.264, as it is powerful and flexible enough to run the entire gamut of applications, from the smallest resolution mobile phone application to the highest resolution High Definition TVs.

From a silicon solution perspective, success depends on an architecture's ability in handling the large data bandwidth requirements of High Definition video, six times that of standard definition video, the compute complexity of standards like H.264 and VC-1, while providing legacy support for a multitude of existing standards, at mass market cost points.

The Compression Problem

High Definition processing is six times more computationally intensive than Standard Definition and requires a new generation of encoders. While decoding (decompression) is quite straight-forward, encoding (compression) is tricky. The high complexity of the encoding process requires computational resources that, given the current architectural approaches, are difficult to achieve in a single chip at a reasonable price.

The plethora of legacy, current, and emerging standards including MPEG-1, MPEG-2, MPEG-4, Divx, H.264, VC-1 and AVS, were designed so that the encoding process contains more complexity than the decoding process. While a standard determines the decoding algorithm, there are many possible encoding algorithms. The time and effort required to develop an encoding algorithm provides a barrier to entry that has previously limited the number of companies in the market.

Better encoding algorithms result in lower bit rate and higher video quality. The encoding algorithms improve as the market matures and a solution ideally should allow for implementation of proprietary encoding algorithms. Field upgradeability is critical to avoiding obsolescence.

Current silicon solutions for video compression are based on one of three broad architectural approaches, a fully programmable approach, using general purpose processors or Digital Signal Processors (DSPs), the hardwired ASIC approach, comprising of fully hardwired logic, and fully-programmable multi-processor approach.

Fully Programmable Approach

Solutions in this category typically consist of a high-powered DSP or VLIW (very long instruction word) processor that serves as the video processor and system controller. Though this approach is very flexible, and has faster development times, it is very inefficient at processing fixed functions which are core to video compression. This results in higher clock speeds which lead to higher power consumption as well. Typically, at higher resolutions, multiple devices might be required for video processing.

The Hardwired/ASIC Approach

Solutions in this category typically consist of a system processor handling higher level system functions while the video processing is done entirely in hardware, with minimal software control. Though this approach is typically cheaper and lower power, it results in a fixed function device which does not offer any flexibility or extensibility that is necessary for success given the plethora of standards. Moreover, errors are difficult and expensive to correct which leads to longer development cycles.

Fully Programmable, Multi-Processor Approach

A third category exists, one that is a superset of the basic programmable version. This architecture specifies multiple instances of programmable elements like CPUs and DSPs, or a combination thereof. The result is a fully programmable architecture capable of achieving higher compute requirements by parallelism, thereby keeping system clock speeds lower than the single processor approach. It however has very high software development costs, and typically the number of processing elements required increases with increase in resolution.

### SUMMARY

An advantage of the embodiments described herein is that they overcome the disadvantages of the prior art. Another advantage of certain embodiments is that they overcome the problems described above. Yet another advantage of certain embodiments is that they combine advantageous features from prior art solutions described above.

These advantages and others are achieved by a function based multi-processing system for video compression and decompression. The system includes one or more functional elements, a high performance video pipeline, a video memory management unit, one or more busses for communication, and a system bus for communication between higher level system resources, functional elements, video pipeline, and video memory management unit. Each functional element selectively includes one or more customized processor elements, one or more hardwired accelerator elements or one or more customized processor elements and hardwired accelerator elements.

These advantages and others are also achieved by a video encode and decode system that includes a plurality of functional elements, a high performance video pipeline, a video memory management unit, a video input unit, a video output unit, one or more busses for communication, and a system bus for communication between higher level system resources, functional elements, video pipeline, and video memory management unit. Each functional element selectively includes one or more customized processor elements, one or more hardwired accelerator elements or one or more customized processor elements and hardwired accelerator elements.

These advantages and others are also achieved by a function based multi-processing system that includes means for identifying the format of the input bitstream, means for decoding or decompressing the input bitstream, means for encoding a raw input video stream into one of many formats, means for transcoding a bitstream from one format to another, and means for translating an incoming bitstream to a different bitrate.

### DESCRIPTION OF THE DRAWINGS

The detailed description will refer to the following drawings, wherein like numerals refer to like elements, and wherein:

FIG. 1 is a block diagram of an embodiment of a configurable functional multi-processing architecture for video processing.

FIG. 2 is a diagram showing different functional layers in an embodiment of the software architecture.

FIG. 3 is a block diagram of an embodiment of a configurable functional multi-processing architecture for video processing, implemented as a system-on-chip IC.

FIG. 4 is a block diagram of an exemplary system control that may be connected to an embodiment of a configurable functional multi-processing architecture for video processing.

FIG. 5 shows different layers in an encoded video bitstream of an embodiment, with a video decode process perspective.

FIG. 6 illustrates an exemplary arrangement of functional elements in series, in accordance with an embodiment, from a video decode process perspective.

FIG. 7 is a flowchart illustrating an embodiment of a video decode process using an embodiment of a configurable functional multi-processing architecture for video processing.

FIG. 8 illustrates an exemplary arrangement of functional elements in series, in accordance with an embodiment, from a video encode process perspective.

FIG. 9 is a flowchart illustrating an embodiment of a video encode process using an embodiment of a configurable functional multi-processing architecture for video processing.

FIG. 10 illustrates an exemplary arrangement of functional elements in series, in accordance with an embodiment, from a video encode perspective.

### DETAILED DESCRIPTION

Described herein are embodiments of a configurable functional multi-processing architecture for video processing. The architecture may be utilized as integrated circuit devices for video compression based on multi-processing at a functional level. The architecture may also provide a function based multi-processing system for video compression and decompression, systems and methods for development of integrated circuit devices for video compression based on multi-processing at a functional level.

A core of functional multi-processing, as described in embodiments herein, involves dissecting the video process into a chain of discrete functional elements. Each of these functional elements may then be realized using a combination of software running on customized processors and function specific hardware logic engines tightly coupled to the same via a dedicated interface.

Generic processors are efficient at processing random functions. This makes them ideal for running control functions which are essentially random in nature. Additionally, software running on the processors provides—feature flexibility for multi-standard support and extensibility to next generation block-based standards. Hardwired logic is very efficient at fixed functions like math processes, and is an ideal choice for running compute intensive process loops. The hardwired logic engines, by the way of their efficiency, provide the raw compute power required for high performance high bandwidth applications.

Embodiments described herein capitalize on the above characteristics of CPUs and hardwired logic by using a combination of processors and tightly coupled hardwired logic. Higher efficiency is achieved by further customizing individual processor cores by adding function specific hardwired extensions to the base instruction set. The customized processors are, therefore, responsible for video standards specific functions, non-compute intensive tasks, and higher level control, thus providing DSP-like programmability. The function specific hardware engines are responsible for accelerating fixed function tasks, especially those demanding heavy compute effort, providing ASIC-like performance.

In an extension of capabilities, multiple processors can access a single hardware engine via a single, tightly-coupled interface, and conversely, a single processor can drive multiple hardware engines via a similar single, tightly coupled interface. The decision to use either of these extensions is based on the application at hand.

Besides the core processing elements, embodiments include a high performance video pipeline unit including an intelligent pipeline, internal buffers and queues, and their control units helps keep the process in step. The pipeline unit, in conjunction with the internal queues, removes the need for having external memory access capabilities on every functional element. Hence, in an embodiment, only a select few functional elements have access to external memory, thereby reducing traffic on the system bus, and increasing throughput. In embodiments, system efficiency is also brought forth by a video memory management unit that incorporates enhanced memory access units and video-source based memory storage schemes. The memory access units help improve efficiency of data storage and retrieval from the external memory, thereby increasing system throughput.

Embodiments described herein bring forth the following advantages to silicon based video compression and decompression: the insofar unachievable (by current architectures) ideal balance of performance and programmability, low cost, feature flexibility, scalable power consumption with concurrent support for high performance high bandwidth applications as well as low-power portable applications, and extensibility to future block-based video compression standards.

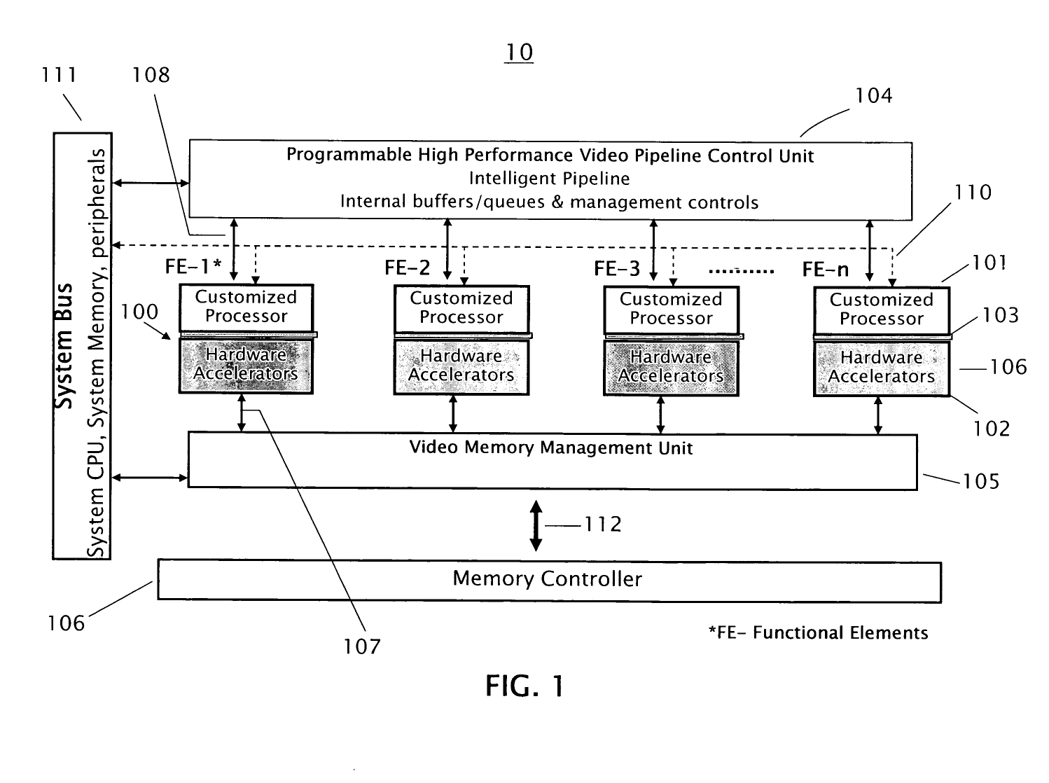

With reference now to FIG. 1, shown is an embodiment of configurable functional multi-processing (CFMP) architecture, system 10 for video processing. As shown in FIG. CFMP architecture includes one or more functional elements (FE) 100, programmable high performance video pipeline control unit 104, video memory management unit 105, memory controller 106 and system bus 111.

CFMP architecture provides an architectural approach for design and development of video compression integrated circuits that delivers high performance while maintaining feature flexibility in the context of standards based video. Embodiments of CFMP architecture utilize advantages of the hardwired approach and the programmable approach and provide a method for developing video processing solutions that are high in performance and flexibility, while consuming very low power and silicon area.

CFMP architecture also provides a method for development of integrated circuit devices for video compression based on multi-processing at a functional level. Such a method, e.g., using CFMP architecture 10, involves dissecting the given process, video compression in an example, into discrete FEs 100 and realizing each FE 100 as a combination of a software programmable processor sub-element and a configurable hardware sub-element that is tightly coupled to the processor element. FEs 100 are then arranged in a pipeline via intermediate buffers and queues to realize the compression process.

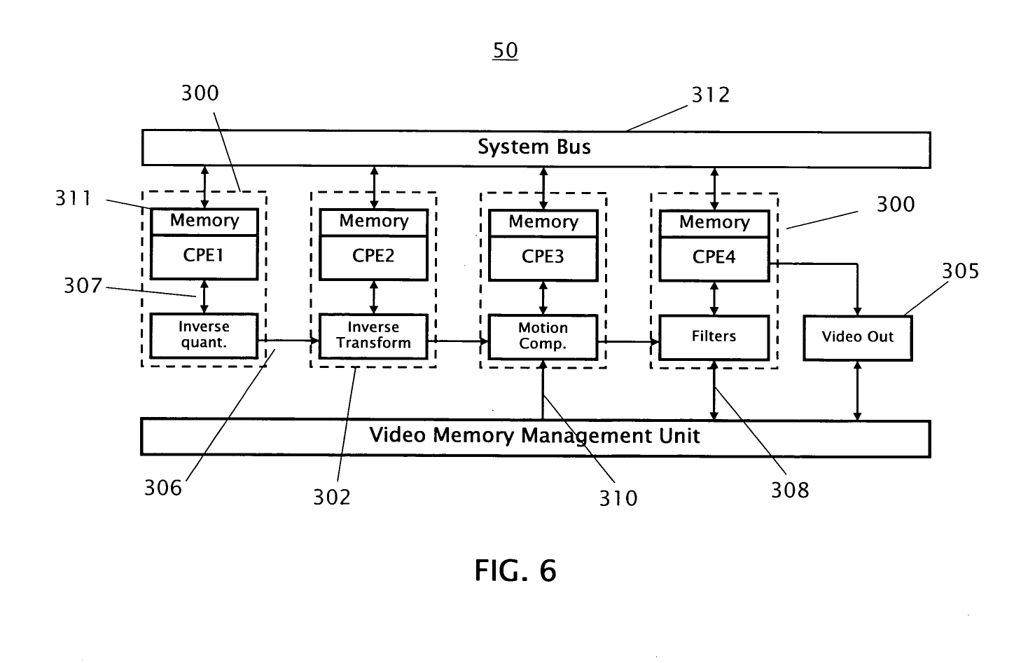

With continued reference to FIG. 1, in an embodiment, FE 100 is an integrated circuit (IC) that includes customized processor element (CPE) 101 and hardware accelerator element (HAE) 102, both customized for a certain function. CPE 101 is a software programmable processor with customized instructions specific to the function being executed in addition to its basic instruction set. A single CPE 101 can connect to one or more HAEs 102. HAE 102 is a circuit which includes software configurable math and memory access logic along with finite state machines (FSM) that control the same. A tightly coupled HAE 102 is a hardware element that connects directly to one or more CPEs 101, e.g., via a dedicated bus interface (see interface 308 in FIG. 6), separate from system bus interface 111. A tightly coupled HAE 102 is also configurable by CPEs 101 it connects to via a set of unique function-specific programmable registers, also known as the hardware abstraction layer (HAL) 103. A pipeline is understood to be a set of logic circuits, also called stages, arranged in a sequential fashion. External video memory is understood to be video memory situated external to IC 10 that is predominantly used for storage of processed video frames for processing of future frames and possibly display of the same.

Based on function, the FEs 100 connect either to system bus 111, have external memory access, or both. The connection to system bus 111 provides the ability to dynamically configure control software running on CPEs 101, while the memory access capability provides a means for HAEs 102 to retrieve and store data, video frame data in this case. All CPEs 101 connect to system bus 111, while only select HAEs 102 have access to video frame buffer memory (not shown in FIG. 1). HAEs 102 access to video frame buffer memory is determined by its function, and by the nature of partitioning of tasks between software functions running on its CPE(s) 101, and tasks provided by neighboring HAE(s) 102 in the pipeline.

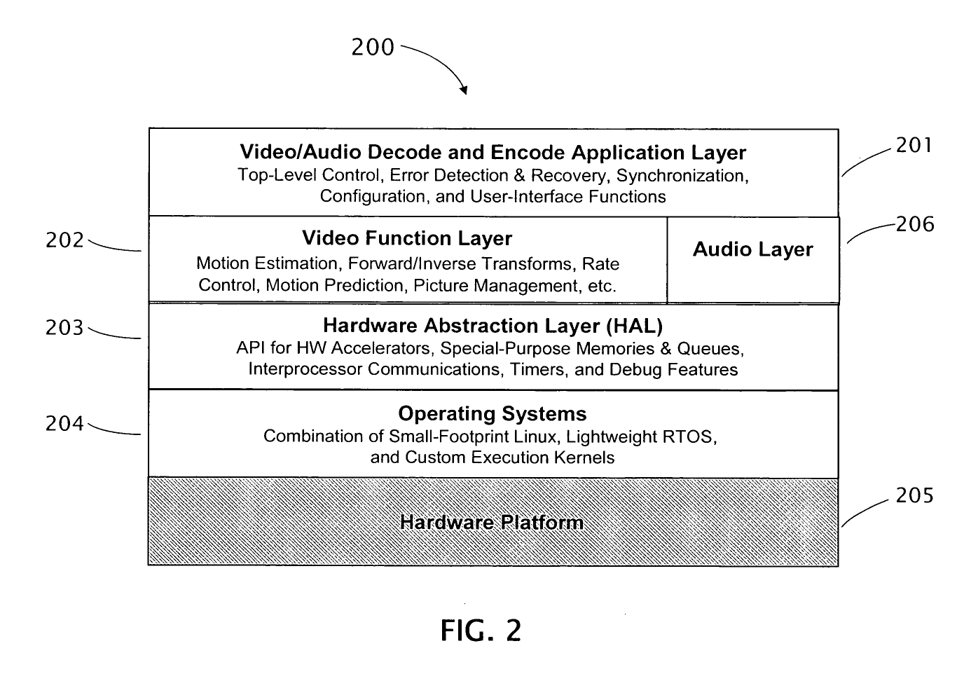

With continued reference to FIG. 1, HAEs 102 are arranged in sequential fashion forming the video pipeline. In domino fashion, each HAE 102 is enabled by its predecessor in the pipeline, and in turn enables the next HAE 102 in the pipeline. HAEs 102 communicate between themselves by passing highly function specific control and data tokens, while their corresponding CPEs 101 communicate via tokens using shared memory spaces, also called mailboxes. CPEs 101 communicate with attached HAEs 102 via a hardware abstraction layer (HAL) (see HAL 203 in FIG. 2). The order of HAEs 102 in the pipeline can change based on the process at hand, i.e. video decode or video encode or both.

Selective HAE access to video frame buffer memory results in lower bandwidth across the memory bus 112, thereby making it possible to achieve performance levels required for High Definition video processing without increased clock frequency or silicon area. To ensure availability of relevant data to all FEs 100, memory access capability not withstanding, HAEs 102 are arranged in a pipelined fashion. Intermediate buffers between HAEs 102 allows for access to intermediate, processed or raw data required by subsequent HAEs 102 in the functional sequence.

With continued reference to FIG. 1, the pipelining provides a domino-style architecture, wherein individual FEs 100 can be configured independently of one another, and a subsequent HAE 102 is activated by the completion of processing by the previous HAE 102. This creates flexibility in the architecture wherein data is processed as and when available, resulting in higher throughput. Each HAE 102, and in turn the overlying FE 100, is thus set up for maximum performance, to process its data as quickly as possible. HAEs 102 also connect to external video buffer memory on a need-to basis determined by their function set and their relative position in the video pipeline. Facilitating this connectivity is video memory management unit/interface 105.

Video memory management unit 105 provides the interface between HAE's 102 and video memory controller/interface 106. External memory accesses can prove very wasteful if adequate care is not given to how data is being accessed and how much of the accessed data is discarded due to the row-wise storage configuration of data in memory. For high definition video the overall available bandwidth is critically coupled to the volume of external memory accesses and their efficiency. To this end, in an embodiment, video memory management unit 105 includes enhanced direct memory access (DMA) engines that are highly mode aware and can be configured to for example, fetch the correct amount of data from external memory for HAE 102 based on HAE's 102 current mode of operation. Also provided in video memory management unit 105 is a set of image based memory management schemes or system. These schemes, based on characteristics of incoming and/or outgoing video streams, dictate how video frame data is to be stored in external memory. Such schemes may include representing images in memory as: (A) Progressive frames: frames are stored in progressive line fashion, or (B) Interlaced frames: frames stored as separate fields. Each of the above frame modes (Progressive Frame mode and Interlaced Frame mode) support the next mode level: (1) Raster Scan Frame pixels are stored in left-to-right, top-to-bottom fashion; (2) Block raster: Frames are stored as Contiguous Macroblocks (16×16/8 pixels) or Contiguous sub-blocks (that constitute a 16×16 macroblock); and (3) Mixed block raster: Each macroblock can either be stored as contiguous line of 256 pixels or as 2 contiguous lines of 128 pixels each (field based MB raster). In other words, incoming frames can be stored as (A) or (B). Furthermore, these frames can be represented in raster scan or block raster scan fashion. These schemes and other allowable configurations are user programmable in a dynamic fashion. These schemes, when used in conjunction with the mode aware DMA engines, provide highly efficient memory accesses thereby reducing wastage, and freeing system bandwidth for other functions. This results in increase of overall system throughput.

In an architectural approach of the embodiments described herein, an algorithm or video process (decompression for example) is decomposed into a sequence of component or functional processes. Each function or component is then profiled and analyzed for data and memory intensive processes, control loops and possible performance bottlenecks. The resulting information is then, for each component, translated into processes that run on CPE 101 and processes that are implemented in hardwired logic gates (HAEs 102). Processes that run on CPEs 101 are further analyzed for efficiency, and performance deficient areas are bolstered by addition of custom instructions that accelerate the same, resulting in a function specific processor element, also known as CPE 101. HAE 102 is optimized to perform its given function(s) efficiently using a minimal number of logic gates. HAE 102 implementation encompasses a set of accelerator functions that allows for its configurability within certain bounds. For example, HAE 102 accelerating the motion compensation function in a video decode process could provide support for multiple standards like MPEG-1, MPEG-2, H.264, VC-1, etc. Hence HAE 102 is configurable across the standards it is designed to accelerate. Furthermore, the analysis of the video process or algorithm could result in functional elements consisting of multiple CPEs 101 and a single HAE 102, a single CPE 101 and multiple HAEs 102, a CPE 101 only, or an HAE 102 only.

With continuing reference to FIG. 1, system 10 illustrates an architectural approach of embodiments described herein. This architectural approach, the CFMP architecture, serves as a platform from which application specific ICs can be implemented. As noted above, embodiment of system 10 shown in FIG. 1 comprises a pipeline one or more FE-n 100 each including CPE 101 tightly coupled to HAE 102 via HAL 103 unique to the FE-n 100. HAEs 102 have access to external video memory via the memory controller interface 106. In an application specific embodiment, only certain HAEs 102 have access to external memory via interface 107 with video memory management unit 105. Data generated by HAEs 102 is handled by video memory management unit 105 which includes enhanced Direct Memory Access (DMA) engines that are mode-aware. The DMA engines employ a range of programmable image based memory storage schemes for efficient storage and retrieval of video frame data in external video memory. HAEs 102 are interconnected via interface 108 to video pipeline unit 104. Video pipeline unit 104 is programmable and provides internal buffering mechanisms that can be managed by software. This flexible buffering scheme allows for HAEs 102 and even entire FEs 100 to be bypassed completely anywhere in the pipeline. HAEs 102 are bypassed when hardware acceleration is not required in a certain mode of operation. FEs 100 are bypassed when entire functions are either not required for a given mode of operation, or when their functions are performed by software in the system processor on system bus 111. CPEs 101 communicate with each other via shared memory also known as mailboxes (not shown).

In embodiments, the software component is critical to the performance and is tightly coupled to the hardware, e.g., as shown in FIG. 1. With reference now to FIG. 2, shown is an exemplary software architecture 200 that may be implemented by embodiments of CFMP architecture. Software architecture 200 layers correspond to system 10 in FIG. 1, and include examples of functions at each layer. Starting from the highest layer, application layer 201 provides a method for user video applications to call on compression and decompression capabilities of system 10 in FIG. 1. Calls from application layer 201 are split into function specific calls and then sent to video function layer 202. In video function layer 202, calls are handled by CPEs 101 in corresponding FEs 100. Audio functions are handled at this layer as well in audio layer 206. CPEs 101 in turn drive configuration data to attached HAEs 102 via their section of hardware abstraction layer 203. Finally, configuration calls are translated to hardware commands by the lowest layer, operating system layer 204. OS layer 204 directly bolts on to hardware platform 205.

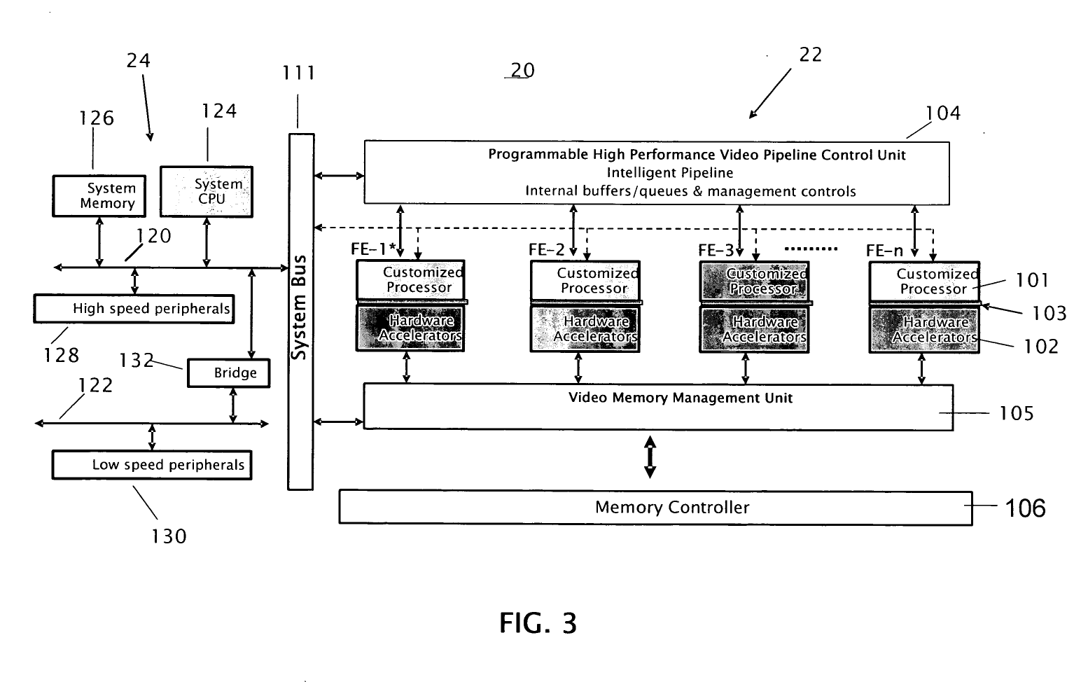

With reference now to FIG. 3, shown is another exemplary embodiment of CFMP architecture. The embodiment shown is system-on-chip IC 20. Such system 20 includes two parts, video-core part 22, and a system control part 24, connected by high-speed system bus 111. Subsystem 22 is described in detail as system 10 in FIG. 1. System control part 24 typically includes high speed bus 120 and low speed bus 122. System CPU 124, system memory controller 126 and a set of high speed peripherals 128 reside on high-speed bus 120 while lower speed peripherals 130 reside on low-speed bus 122 which is typically connected to high-speed bus 120 via system bridge 132.

With reference now to FIG. 3, shown is a typical example of system control 24 for a video compression embodiment of CFMP architecture. High-speed bus 120 has a selection of connectivity peripherals 128 for networking 134 and external buses 136, memory controller 138, system CPU (not shown), system multiplexer/de-multiplexer 140, and audio DSP 142 for handling audio encode/decode functions, among others. The synchronization between audio and video is handled by system CPU. Low-speed peripherals 130 include system timers, interrupts, serial data/control interfaces, system configuration control, etc., as shown.

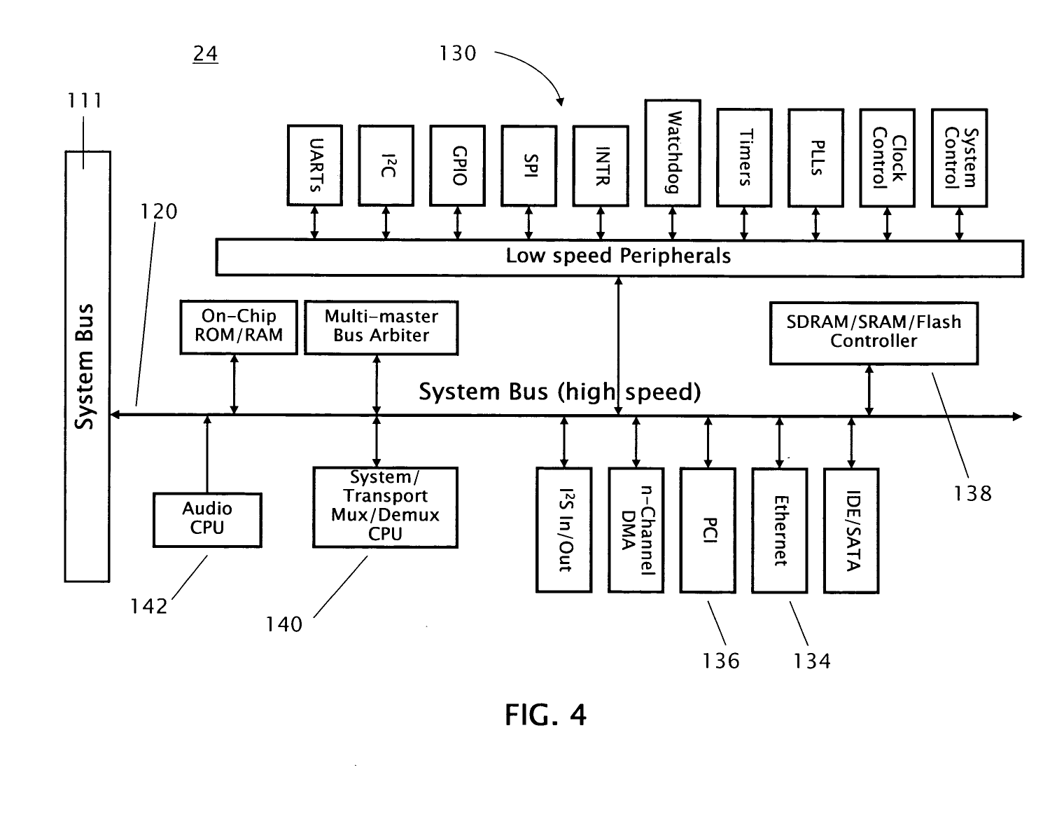

With continued reference to FIGS. 3 and 4, system 20 built on this architecture is capable of multi-threaded operation on two levels. System 20 is capable of switching seamlessly between multiple input streams each possibly of a different format. For example, in a video decode application, system 20 is capable of switching dynamically between an incoming MPEG-2 stream and an H.264 stream. The second level of multi-threaded operation happens at video core level 22 (system 10 in FIG. 1), in which the decode process is split into multiple processes or threads on a functional basis, each functional thread/process running on CPE 101 and its FE 100.

This capability of switching seamlessly between multiple input streams each possibly of a different format provides a great degree of flexibility and configurability in system operation. The configurability allows for efficient error recovery where in errors and bottlenecks can be addressed from the system level down to the functional level wherein individual stages of the pipeline can be reset or reconfigured. It also provides the ability to trade-off performance with power consumption dynamically by allowing the system process to turn off individual HAEs 102 and swap them with complementary soft processes running on corresponding CPEs 101 or leave HAEs 102 in line for higher performance.

Referring now to a video decompression (decode) application of the CFMP architecture, the video decode flow consists of six (6) individual functions in the following sequence: entropy decode, inverse quantization, inverse transform, motion compensation, reconstruction and filtering. The entropy decode process parses the bitstream extracting control and data parameters for the other processes, all of which are downstream from it. From an implementation perspective the inverse quantization and inverse transform functions are implemented together; similarly, the motion compensation and reconstruction processes are implemented together as well.

All current video compression standards like MPEG1/2, MPEG-4, and H.264 use hybrid block-based transform motion compensation and transform video coding method. They also based on a basic set of functional elements as described above.

Given the above similarities amongst block-based standards, they differ in degree of complexity at the component level as well as the range of mode set available. For instance, the smallest pixel block that motion estimation in MPEG-2 operates on is 16×8, but H.264 allows the usage of sub-blocks as small as 4×4. MPEG-2 does not stipulate an in-loop filter, but H.264 does.

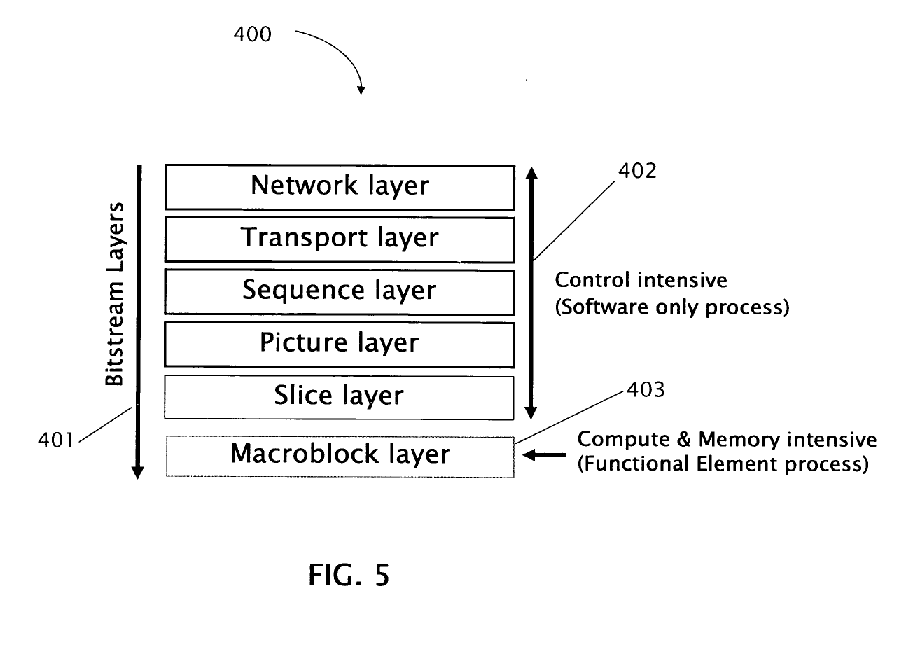

With reference now to FIG. 5, shown is a typical bitstream (encoded) 400 can be broken down into six (6) embedded layers 401 of data/control for each FE 100. The five higher layers, network layer, transport layer, sequence layer, picture layer and slice layer, are control layers 402 and contain parametric data that sets up the decode processor (e.g., an entire decoder core that includes multiple FEs 100) for the data that follows in the sixth layer, macroblock layer 403. As opposed to the control layers 402, which are control intensive, software only processes, macroblock layer 403 places demanding requirements on memory and data processing.

Regarding partitioning tasks between hardware and software, software running on a CPU is better at performing tasks that are random in nature, involve decision making, and provide higher level control of functions; hardware is better suited to constant function tasks, especially those demanding heavy compute effort like math functions.

Adapting these principles to the bitstream layers 401 in FIG. 5, it makes sense then to implement the network, transport, sequence, picture, and slice layers fully in software, running on system CPU and individual CPEs 101. Macroblock layer 403, given its demanding requirements on data processing and memory accesses, is implemented in FEs 100 as combination of translated low level control software running on CPE 101 (for mode control) and the majority of the processes running on hardwired logic, HAE 102. Typical functions implemented in hardware at this level include filtering functions, direct memory access engines, other related math functions, and pixel manipulation operations.

With reference now to FIG. 6, shown is an exemplary embodiment of CFMP architecture as applied to multi-standard video decompression application. System (core) 50 includes four FEs 100 connected sequentially in a domino pipeline fashion to decode incoming video streams and video-out module 305 that reformats the constructed frames for display. Each FE 300 typically operates on a macroblock of pixels, a macroblock comprising of 16×16 rectangle of pixels. Additionally, FEs 300 are structured to operate at the lowest common denominator of block size, which in the case of H.264 is 4×4 for motion compensation and 2×2 for transform.

An exemplary FE 300 in a real world application (video decode) is illustrated in FIG. 6. Each FE 300 in this embodiment comprises a CPE 301 and an HAE 302 directly coupled to each other via unique bus 307. This direct connection also represents the hardware abstraction layer (HAL).

In the embodiment of the application, system 50, CPE 301 performs dual functions of bit stream decoding (entropy decoding) and inverse quantization. The video pipeline includes HAEs 302 for inverse quantization, inverse transform, motion compensation, and a filter engine, all connected in a domino fashion. Each of the above HAEs 302 is controlled by its own associated CPE 301 and is connected to the next HAE 302 in the pipeline via unique interface 306. It is important to note that the interface between any two HAEs 302 is dependent on the functions of the two HAEs 302 and is different from other such interfaces. For example, interface 306 between inverse quantization HAE 302 and inverse transform HAE 302 is different from interface 306 between inverse transform HAE 302 and motion compensation HAE 302. Only certain HAEs 302, based on functional and bandwidth analysis require direct access to video memory. This is expressly done to reduce unnecessary traffic on the memory bus, thereby increasing system 30 performance at higher resolutions. In the embodiment shown, only two HAEs 302 have access to video memory. Motion compensation HAE 302 has read-only capability, via interface 310, while filter engine (filter HAE 302) has both read and write capability via interface 308.

In the present architectural approach, for applications targeting a single standard each HAE 302 may include accelerator elements specific to that standard; for multi-standard applications HAE 302 elements are optimized to support the specified standards while keeping logic additions to a minimum. This cross-standard optimization also includes significant software support by the way of firmware running on the corresponding CPEs 301.

Each CPE 301 has access to its own internal memory 311 for storing software that it executes, and for storing parsed data, intermediate values etc. Executable software is downloaded into these memories by the system controller via system bus 312. CPEs 301 keep in sync by communicating using shared memory allocated for the specific purposes of inter-processor communication. CPEs 301, based on functionality and requirement, may have direct access to system bus 301 as well.

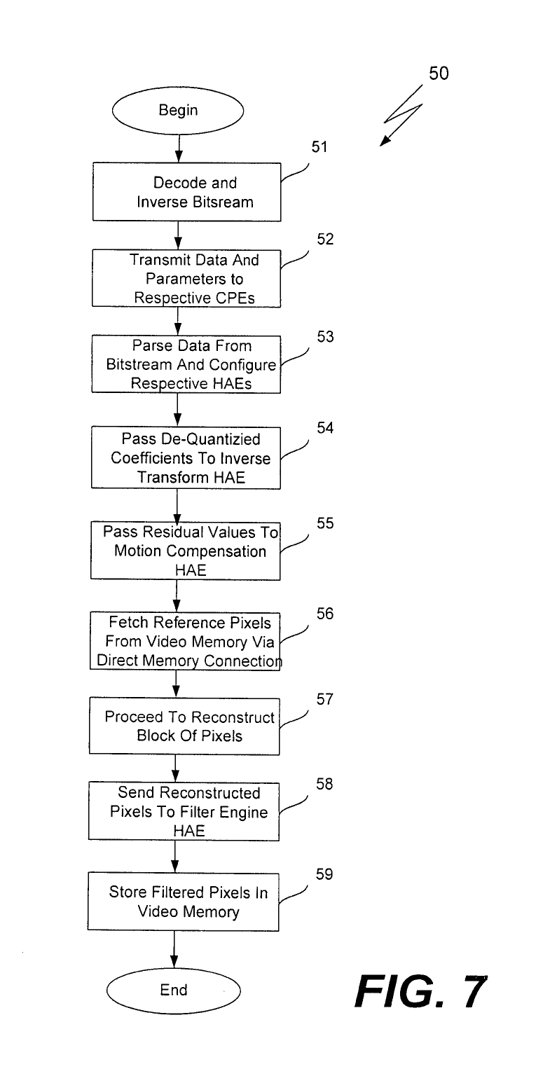

With reference now to FIG. 7, shown is a flowchart illustrating an exemplary video decode process 60 based on system 50. Embodiments described herein may include instructions, e.g., for execution by CPEs, stored on computer readable mediums for performing the processes described herein, including those shown in FIG. 7. With reference to FIG. 7, the bitstream is decoded and inverse scanned by CPE1 301, block 51; data and parameters generated from this process, like motion vectors, quantized coefficients, and mode information, is transmitted to the respective CPEs 301, block 52. CPE1 301 configures the inverse quantization HAE 302 while the other CPEs 301, with the required parsed data from the bitstream, also configure their respective HAEs 302 accordingly, priming the video pipeline, block 53. As the inverse quantization process is completed, de-quantized coefficients are passed on to the inverse transform HAE 302 via intermediate buffers and control handshaking, block 54. The inverse transform HAE 302 generates residual values that are then passed on to the motion compensation HAE 302, via interface 306, comprising buffers and control handshaking as well, block 55. The use of intermediate buffers exempts the corresponding HAEs 302 from needing direct memory access. While the inverse quantization and inverse transform processes are ongoing, the motion compensation HAE 302, based on its configuration by its CPE2 301, fetches reference pixels from video memory via its direct memory connection, block 56. Once the residual coefficients from the inverse transform process are available, the motion compensation HAE 302 proceeds to reconstruct the block of pixels in questions, block 57. The reconstructed pixels are then sent to the filter engine HAE 302, block 58, which performs in-loop filtering (in the H.264 case) and stores the filtered pixels back in video memory for use by subsequent pixel blocks, block 59. As is evident, HAEs 302 are enabled by completion of an event by their predecessors thereby forming the domino pipeline. The advantage of this approach is the individual FEs 300 are configured and run in parallel. At lower resolutions, individual FEs 300 can shut down until the next data set is available, thereby saving power.

Referring now to a video compression (encode) application, an exemplary video encode flow consists of seven (7) individual functions: prediction, forward transform, quantization, entropy coding, reconstruction and filtering. In the prediction stage, the encoder does inter and intra prediction. The better result of the two predictions is then run through the forward transform; the resulting coefficients are then quantized. The quantized image is then sent through the inverse process of reconstruction which includes inverse quantization and inverse transform stages. This reconstructed image is subtracted from the original image and the resulting difference, also known as residuals (prediction error) is then entropy coded along with any motion vectors and reference information in the syntax pertaining to the chosen standard. The reconstructed image is then optionally run through a de-blocking filter before being stored as reference for future frames. The reconstruction process described above is basically the decode process, hence decoder components find re-use in the encode case.

In the encode flow, the motion estimation process pertaining to inter-frame prediction is very computationally intensive. This process involves finding the best fit for a macroblock of information in the image to be encoded from a previously coded frame or frames. This essentially involves exhaustive searching of reference frames, calculation of differences at each search stage, performing sub-pixel interpolation, and possibly having to support block sizes as small as 4×4 pixels (H.264). This process at higher resolutions can be extremely demanding on the memory bandwidth and computational performance. To reduce the computational requirements to acceptable levels, many search algorithms have been proposed that use heuristics and other parameters to find matches without needing exhaustive searches. Taking things to the next level, combinations of well known algorithms have been put to use based on characteristics of the incoming video as well as the performance expectation at the system level. Clearly the motion search algorithm or strategy is critical to performance and compression quality. This translates to the requirement on the part of the system to be flexible and configurable, yet be able to provide the required computational performance to maintain required throughput.

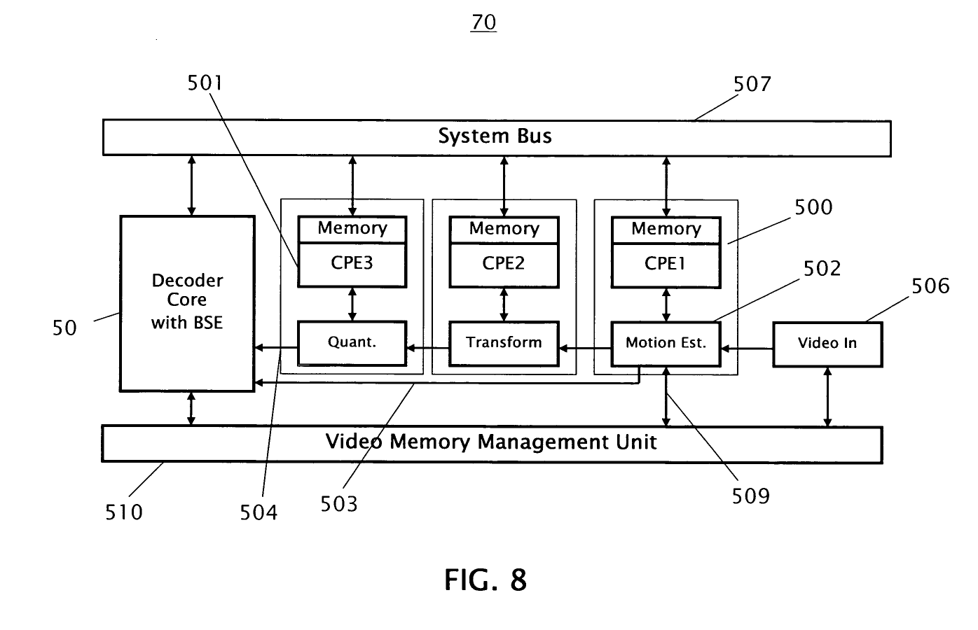

With reference now to FIG. 8, shown is an exemplary embodiment of CFMP architecture as applied to multi-standard video compression application. The current CFMP architectural approach naturally provides the perfect mix for achieving required performance levels while providing the required flexibility. For example, user configurable functions, like search algorithms, hardware state programming and associated functions like rate distortion optimization, block size control, etc., are implemented in CPEs, while computationally intense functions like reference pixel fetching, pixel comparisons, SAD calculation, sub-pixel interpolation etc. are handled in HAEs.

The partition between software and hardware is mainly based on the criterion that the software performs the operations only associated with the current macroblock, and the hardware accelerates the operations performed on reference macroblocks.

With continuing reference to FIG. 8, shown is an exemplary embodiment of system 70 as applied to multi-standard video compression application. Core 70 includes three FEs 500 for the forward video encode process including motion estimation (both intra & inter), forward transform, and quantization. Also included in the pipeline is decoder core 50 sans bitstream decoding which takes care of the inverse quantization, inverse transform and motion estimation processes. Included in this embodiment is a bitstream encoder (not shown).

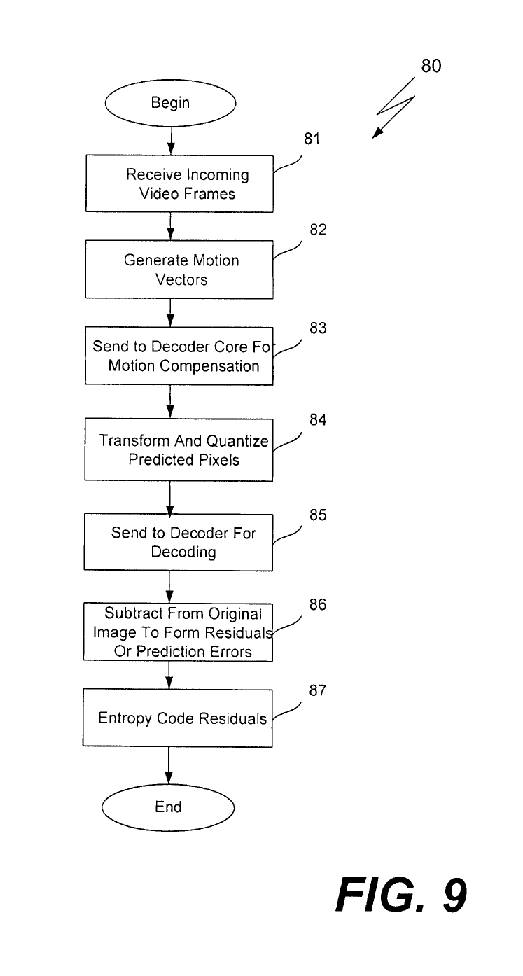

With reference to FIG. 9, shown is a flowchart elucidating an embodiment of a video encode process 80 based on system 70. Embodiments described herein may include instructions, e.g., for execution by CPEs, stored on computer readable mediums for performing the processes described herein, including those shown in FIG. 9. These instructions may be stored as software. With reference to FIG. 9, incoming video frames 506 are received, block 81. Motion vectors generated, block 82, by the motion estimation process, run on CPE1 501 and motion estimator HAE 502, on incoming video frames 506 are sent to decoder core 50 for motion compensation via interface 503, block 83, while the predicted pixels are transformed and quantized, block 84, before being sent to decoder 50 for decoding via interface 504, block 85. The decoding involves inverse quantization and inverse processes resulting in a reconstruction of the predicted pixels. These are then subtracted from the original image to form residuals or prediction errors, block 86. The residuals, along with the motion vectors (if any) and other syntax information are entropy coded, block 87. This process, in the embodiment shown, is performed by CPE3 501. As part of the optimization on the memory bandwidth front, only decoder core 50 and motion estimation HAE 502 via interface 509, two functions that are most memory intensive, have access to the video/frame buffer memory 510. The configuration of the individual CPEs 501 is done by system controller CPU (not shown) residing on system bus 507.

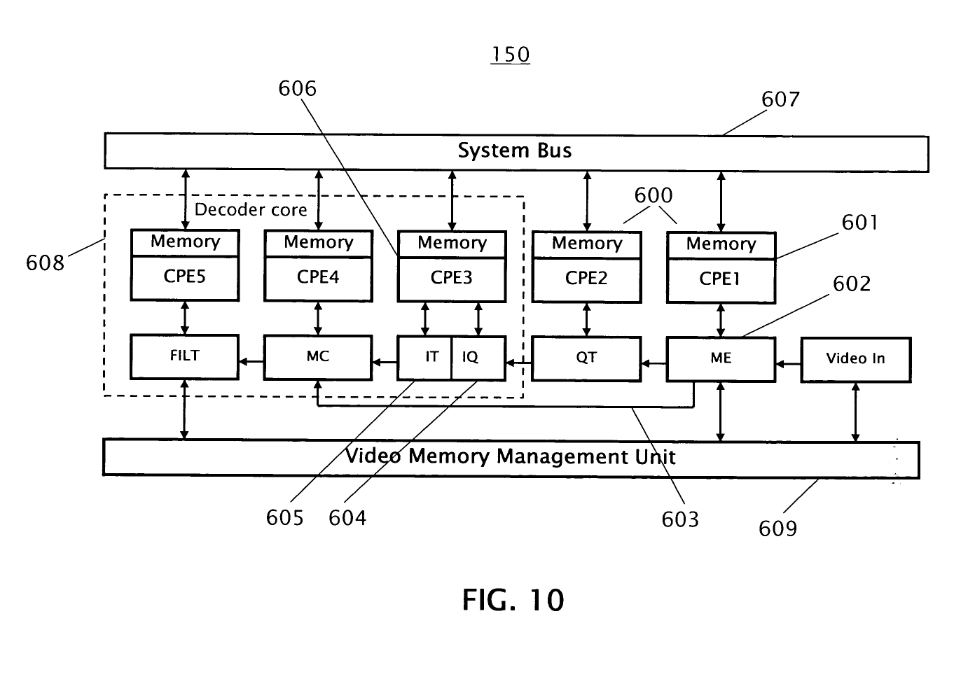

With reference to FIG. 10, yet another exemplary embodiment as applied to multi-standard video compression or video encoding application is illustrated. Core 150 include two FEs 600 for the forward video encode process including motion estimation (both intra & inter) and forward transform/quantization HAEs 603. Also included in the pipeline is a second exemplary embodiment of decoder core 50 wherein the inverse quantization HAE 602 and inverse transform HAE 602 share a single CPE (CPE3) 601. Additionally, CPE2 601 also performs bitstream encoding. Multi-tasking on a single CPE 601 results in reduced area and power dissipation. As part of the optimization on the memory bandwidth front, only the filtering element in decoder core 50 and motion estimation HAE 602, two functions that are most memory intensive, have access to the video/frame buffer memory 609.

It will be clear to one skilled in the art that the above embodiments may be modified in many ways without departing from the scope of the embodiments described herein. For example, each FE need not contain both a CPE and an HAE. Functions that are more control specific can be handled by CPE only functional elements, while functions that are data intensive and requiring minimal flexibility can be implemented in HAE-only functional elements. Also, certain functional elements can be eliminated from the pipeline and be implemented in software or hardware on the system side of the IC. The software-hardware partition in functional elements consisting of CPE(s) and HAE(s) can also be established at various hierarchical levels, for example at the slice boundary levels or macroblock boundary levels in a video compression or decompression application.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

1. A function based multi-processing system for video compression and decompression, comprising;
one or more functional elements, in which each functional element selectively includes one or more customized processor elements, one or more hardwired accelerator elements or one or more customized processor elements and hardwired accelerator elements;
a high performance video pipeline;
a video memory management unit;
one or more busses for communication; and
a system bus for communication between higher level system resources, functional elements, video pipeline, and video memory management unit.

2. The function based multi-processing system of claim 1, in which a functional element, based on characteristics of the function being processed, includes multiple customized processor elements connected to a single hardwired accelerator element.

3. The function based multi-processing system of claim 1, in which a functional element, based on characteristics of the function being processed, includes a single customized processor element connected to multiple hardwired accelerator elements.

4. The function based multi-processing system of claim 1 in which the video memory management unit includes enhanced direct memory access engine, and image based memory management schemes.

5. The function based multi-processing system of claim 1, in which the one or more busses for communication include a first bus that facilitates control interaction between customized processor elements and hardwired accelerator elements within a specific functional element, a second bus that permits data exchange and control communication between the individual functional elements and the external memory, and a third bus that facilitates control processing between functional elements.

6. The function based multi-processing system of claim 5, in which the first bus is a peer-to-peer bus.

7. The function based multi-processing system of claim 5, in which the second bus is a master bus.

8. The function based multi-processing system of claim 5, in which the third bus is a communication bus between functional elements.

9. The function based multi-processing system of claim 1, in which the system bus facilitates control communication and data exchange between system resources, functional elements, video pipeline unit, and the video memory management unit.

10. The function based multi-processing system of claim 9, further comprising a system processor is attached to the system bus, in which the system processor synchronizes audio and video elements and runs bitstream processes and transport layers.

11. The function based multi-processing system of claim 1 including a functional element comprising a customized processor element and a hardwired accelerator element connected together via a hardware abstraction layer.

12. The function based multi-processing system of claim 11, in which a customized processor element includes a base RISC processor and a function specific instruction set that is MPEG-1, MPEG-2, MPEG-4, H.261, H.263, H.264, AVS, VC-1, WMV-9, and DIVX compliant, for said function.

13. The function based multi-processing system of claim 12, in which the one or more customized processor elements run video processes in the sequence, picture, and slice layers.

14. The function based multi-processing system of claim 1, in which a hardwired accelerator element includes function specific hardwired logic that is MPEG-1, MPEG-2, MPEG-4, H.261, H.263, H.264, AVS, VC-1, WMV-9, and DIVX compliant, for said function.

15. The function based multi-processing system of claim 14, wherein the one ore hardwired accelerator elements run video processes in a macroblock layer.

16. The function based multi-processing system of claim 1 in which the high performance video pipeline unit includes an intelligent pipeline including a plurality of functional elements, internal data buffers and queues, and pipeline management mechanisms.

17. The function based multi-processing system of claim 16, in which the intelligent pipeline includes a set of peer-to-peer busses that connect a hardwired accelerator element of a functional element to a hardwired accelerator element of a next functional element in a video process sequence.

18. The function based multi-processing system of claim 17, in which each peer-to-peer bus in the intelligent pipeline connects two hardwired accelerator elements via internal buffers on the boundary of the either hardwired accelerator element.

19. The function based multi-processing system of claim 17, in which the combination of peer-to-peer bus and internal buffers is unique to each pair of connected function specific hardwired accelerator elements.

20. The function based multi-processing system of claim 16, in which the pipeline management controls comprise of mechanisms that, based on the system application, specify which parts of the pipeline, combinations of peer-to-peer bus and internal buffers, are active or otherwise.

21. The function based multi-processing system of claim 4, in which the enhanced DMA engines are function aware.

22. The function based multi-processing system of claim 4, in which the image based memory management system specifies methods for storage of video data in external frame-buffer memory.

23. The function based multi-processing system of claim 22, in which the methods include storage in image raster scan order, storage in macroblock raster scan order, storage in progressive format, and storage in field format.

24. The function based multi-processing system of claim 23, in which macroblock raster scan order comprises of storing the video frame as a sequence of rasterized macroblocks.

25. A video encode and decode system comprising;
a plurality of functional elements, in which each functional element selectively includes one or more customized processor elements, one or more hardwired accelerator elements or one or more customized processor elements and hardwired accelerator elements;
a high performance video pipeline;
a video memory management unit;
a video input unit;
a video output unit;
one or more busses for communication; and
a system bus for communication between higher level system resources, functional elements, video pipeline, and video memory management unit.

26. The function based multi-processing system of claim 25, in which the functional elements include one or more functional elements chosen from a list consisting of:
a motion estimation functional element;
a quantization and transform functional element;
a inverse quantization and inverse transform functional element;
a motion compensation functional element; and
a filtering functional element.

27. The function based multi-processing system of claim 25, in which the motion estimation functional element includes a customized processor element responsible for motion search algorithm optimization, macroblock partitioning and prediction mode determination, and rate-distortion optimization.

28. The function based multi-processing system of claim 25, in which the motion estimation functional element includes a hardwired accelerator element responsible for pixel operations like fetching required pixel data from memory, performing sub-pixel interpolation, calculating sum of absolute differences, and communicating data and control parameters to a quantization and transform functional element via the video pipeline.

29. The function based multi-processing system of claim 28, in which the quantization and transform functional element includes a customized processor element responsible for programming transform and table-lookup parameters.

30. The function based multi-processing system of claim 29, in which the customized processor functional element is also responsible for rate control and bitstream encoding.

31. The function based multi-processing system of claim 28, in which the quantization and transform functional element includes a pair of hardwired accelerator elements, one that performs transform operations on incoming pixels from the motion estimation element, and a second that quantizes the transformed pixels based on program control from the customized processor element.

32. The function based multi-processing system of claim 25, in which the inverse quantization and inverse transform functional element includes a customized processor element responsible for programming inverse transform and inverse quantization parameters for the reconstruction phase based on control from a quantization and transform functional element.

33. The function based multi-processing system of claim 25, in which the inverse quantization and inverse transform element includes a pair of hardwired accelerator elements, one that performs inverse transform operations on incoming pixels from a quantization and transform functional element, and a second that inverse quantizes the inverse transformed pixels based on program control from a customized processor element.

34. The function based multi-processing system of claim 25, in which the motion compensation element comprises of a customized processor element that programs pixel fetch co-ordinates, image co-ordinates in memory, and compensation mode parameters for the inverse transformed and inverse quantized macroblock.

35. The function based multi-processing system of claim 25, in which the motion compensation functional element includes a hardwired accelerator element that fetches pixel data from memory based on motion vector, macroblock, and mode information programmed by software, performs sub-pixel interpolation, and reconstructs the current macroblock using residue information from a inverse transform process.

36. The function based multi-processing system of claim 25, in which the filtering functional element comprises of a customized processor element that programs filter mode, filter parameters and coefficients based on video format.

37. The function based multi-processing system of claim 25, in which the filtering functional element includes a hardwired accelerator element that performs pixel filtering based on rules, and parameters set by software and the filtering functional element writes back filtered pixels into an external frame buffer memory.

38. The function based multi-processing system of claim 25, in which the video pipeline unit comprises of peer-to-peer buses and internal buffers that connect the functional elements in a sequential fashion.

39. The function based multi-processing system of claim 38, in which the motion estimation functional element is connected to a quantization and transform functional element, which is connected to a inverse transform functional element.

40. The function based multi-processing system of claim 39, in which the inverse quantization functional element is connected to a motion compensation functional element, which in turn is connected to a filtering functional element.

41. The function based multi-processing system of claim 39, in which the individual functional elements operate in a domino pipeline fashion, each functional element being enabled by a prior functional element in the pipeline, and once done processing, enabling a following functional element in the pipeline.

42. The function based multi-processing system of claim 25, in which the motion estimation functional element, a motion compensation functional element, and a filtering functional element have access to external frame buffer memory via the memory management unit.

43. The function based multi-processing system of claim 25, in which the motion estimation functional element is also connected to a motion compensation functional element via a peer-to-peer local bus.

44. The function based multi-processing system of claim 25, in which the video input unit is capable of handling one or more types of signals, including one or more types of signals chosen from a list consisting of: an MPEG-1 signal, an MPEG-2 signal, an H.261 signal, an h.263 signal, an H.264 signal, a Divx signal, an AVS signal, a VC-1 signal, and a WMV-9 signal.

45. The function based multi-processing system of claim 25, in which the compressed or encoded output bitstream includes one or more types of signals chosen from a list consisting of: an MPEG-1 signal, an MPEG-2 signal, an H.261 signal, an h.263 signal, an H.264 signal, a Divx signal, an AVS signal, a VC-1 signal, and a WMV-9 signal.

46. The function based multi-processing system of claim 25, in which all functional elements with customized processor elements are connected to the system bus for control and configuration.

47. The function based multi-processing system of claim 25, in which in functional elements including both a customized processor element and a hardwired accelerator element, the customized processor element and hardwired accelerator element are singularly coupled by a peer-to-peer control and configuration bus.

48. The function based multi-processing system of claim 25, in which in functional elements including a hardwired accelerator element only, the hardwired accelerator element is directly connected to the system bus for control and configuration.

49. A function based multi-processing system comprising:
means for identifying the format of the input bitstream;
means for decoding or decompressing the input bitstream;
means for encoding a raw input video stream into one of many formats;
means for transcoding a bitstream from one format to another; and
means for translating an incoming bitstream to a different bitrate.
